(19) United States
(12) Patent Application Publication
(10) Pub. No.: US 2008/0034716 A1
(43) Pub. Date: Feb. 14, 2008

(54) Article of manufacture for haltering a horse or any other like animal typically controlled by the use of a halter

(76) Inventor: Stephen Alllen Foster, Sharpsburg, GA (US)

Correspondence Address: Stephen A. Foster, 68 Barrington Farms Parkway, Sharpsburg, GA, 30277, US

(21) Appl. No.: 11/503,679

(22) Filed: Aug. 14, 2006

(51) Int. Cl. B68B 5/00

(52) U.S. Cl. 54/85

(57) ABSTRACT

An improved halter design and method of haltering an animal. The feature of universal application applies where one size will fit all livestock traditionally haltered for the purpose of control. The design and method of application make it quicker and easier to gain control of the animal than using a traditional halter. The single unit base plate with attached rope simplifies all previous embodiments while maintaining maximum flexibility of use.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of animal halters and more specifically to an article of manufacture for haltering a horse or any other like animal typically controlled by the use of a halter and a method of haltering said animal.

Throughout history horses and other livestock have been haltered to control them while working with them. Halters have traditionally been an assemblage of ropes or straps fastened together in a manner requiring the halter to be slipped over the animals nose and then slid or otherwise attached behind the animals neck. This method requires you to have the animal under control by some other means before applying the halter. The purpose of the halter in the first place is to control the head which then provides control of the animal. A rope or chain was then attached beneath the halter to provide control of the animal. Each halter had to be the correct size for the head of the animal. Halters have always been comprised of leather, rope or nylon straps configured in such a pattern as to provide for the animals nose to fit in before the neck straps are fastened. They have always been made to certain specifications depending on the size of the head or the type of the animal. Halters usually have some degree of adjustment within a narrowly defined range. Metal rings, buckles and clips have been used to hold them together and provide for adjustment. Pure rope halters are held together by a series of knots strategically place to form the desired shape.

Previously one was required to already have some control over the animal in order to put the halter over the nose. This invention allow you to capture the animal with the halter by first laying the rope over the neck and then hooking the rope under the neck effectually forming a lasso. This method is easier and causes much less stress to the animal than the traditional way. The invention can then be slid up the rope to tighten around the neck and quickly and easily flipped over the nose, hooking again to complete the application and provide complete control.

Previously designs were size and animal specific and still needed adjustment over the nose and neck to fit properly. This invention fits all sizes and types of animals from the miniature horse to the draft breeds as well as cows, llamas or any other animal typically controlled by a halter.

Previous designs required removal of the halter before putting on a bridle which provides an opportunity for the animal to escape during the bridling process. This invention can release the nose while still maintaining control through the neck rope. When the bridle is in place the rope can go back over the nose allowing you to handle the animal without resorting to the reins for control.

A lead rope is typically attached to the halter by a clasp of some kind and is a part separate from the halter. This invention incorporates the lead rope into the design of the halter making it fully adjustable for any size head or animal while replacing the straps and separate lead rope all together.

This invention can be easily removed with one hand by simply releasing the rope from the slider whereby the halter simply falls off the head.

### OBJECTS AND ADVANTAGES

From the above description a number of advantages become evident.
a) an animal can be caught and haltered before it has time to try to escape.
b) there is no need to prefit the halter to the selected animal since this invention is automatically full adjustable to all size heads and animals.
c) the invention can be used as a neck rope as well as a halter.
d) the invention is completely self contained, not requiring a separate lead rope to attach to the halter.
e) removal is easy with just two fingers releasing the mechanism so the halter simply falls off the head.
f) this invention can easily be adjusted to fit over a bridle so the animal won't need to be lead by the reins.

### BRIEF SUMMARY OF THE INVENTION

This invention is a one size fits all halter that is designed to more easily and quickly gain control of an animal than previous halters thus reducing stress to the animal.

### DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. <1> is a perspective view of the invention showing how it is used on a horse.

FIG. <2> is a perspective view of the invention without the rope.

FIG. <3> is an exploded view of the invention showing how the rope is secured to the base plate.

FIG. <4> shows the invention fully assembled.

FIG. <5> is a set of dimensioned drawings showing the preferred embodiment.

### DRAWING—REFERENCE NUMERALS

10 base plate

20 attachment tube

30 slider catch

40 hook

50 rope

60 poly drive rivet rope fastener

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

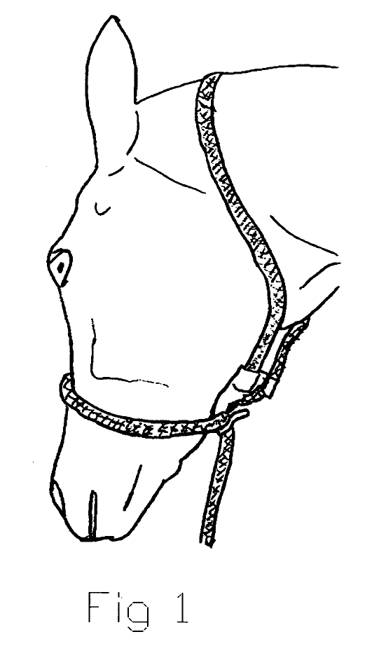

A preferred embodiment of the present invention is illustrated in FIGS. 1 through 5.

FIG. 1 shows how the invention looks when applied in the preferred manner on a horse.

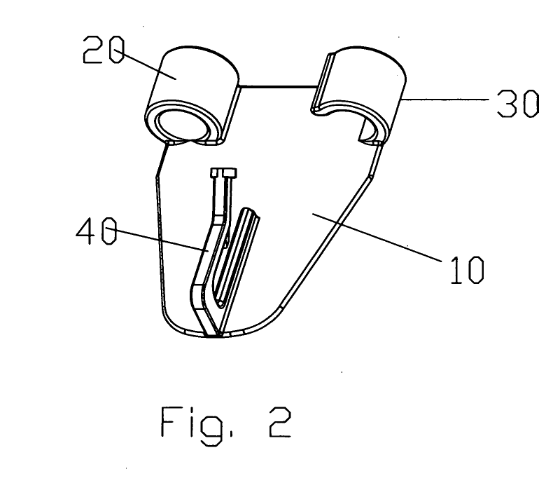

FIG. 2 shows a single injected molded part composed of four features. The base plate 10 forms a contoured base upon which the other three features are s strategically placed. The attachment tube 20 is strategically placed and sized for the preferred size and type of rope. The rope 50 is inserted into the tube 20 where it is secured by using the nylon poly drive rivet 60. Alternate means of fastening could be with knots, screws, clamps, etc.

The injected molded part comprised of the base plate 10, the attachment tube 20, the slider catch 30 and the hook 40 in the preferred embodiment is a high tensile strength, flexible plastic which can be bent repeatedly without breaking yet is strong enough to resist fracture if pulled or stepped on by a horse. This part could be any injectable material such as polyethylene, polypropylene, vinyl rubber, nylon or any other material which can meet the requirements for flexibility and strength. This part could also be manufacture by milling or otherwise forming any material which meets the requirements for strength and flexibility. The rope 20 in the preferred embodiment is a woven blend of nylon and polyethylene fibers but could just as easily be any rope of cotton or synthetic fibers in any combination.

The preferred manner of using the halter to capture and secure an animal is to first lay the rope 60 over the neck of the animal with the right hand. Holding the base plate 10 in your left hand reach under the neck, grabbing said rope and sliding it into the slider catch 30. Slide said base plate up said rope until said rope is secure around the neck of the animal. Loop the slack of said rope over the nose of the animal and hook it in the hook 40. The head is now secured.

An alternate method is to first slide said rope into said slider catch forming a loop. Place said loop over the head of the animal making sure the flat surface of said base plate is facing up toward the jaw of the animal. Then proceed as outlined above.

Removal of the halter can be accomplished by reaching under the neck of the animal and with two fingers of the right hand on either side of said slider catch, squeeze the rope so it comes out of said slider catch. The invention will then fall off the animals head.

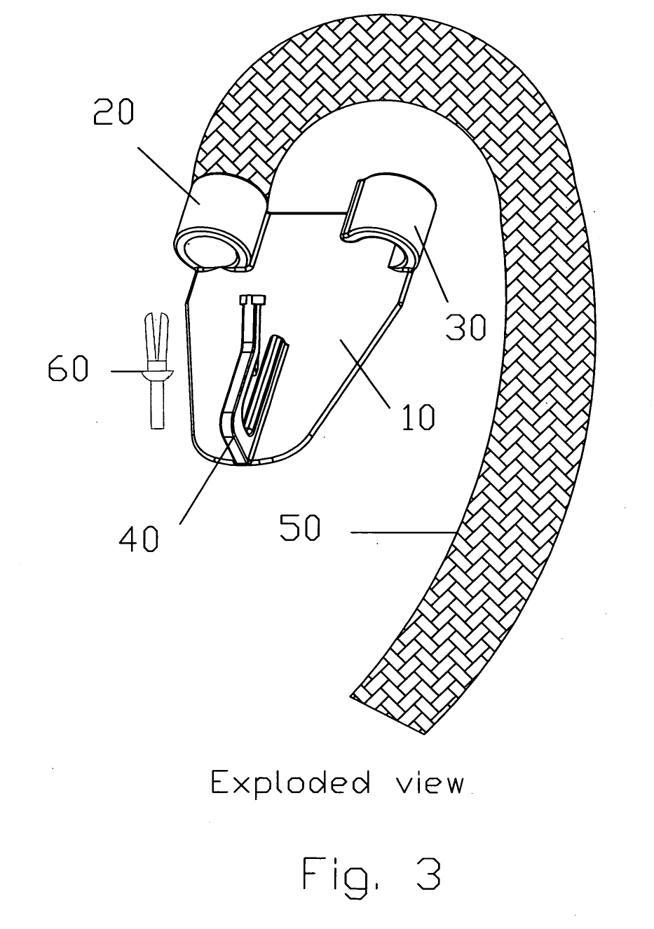

FIG. 3 shows an exploded view of how the rope 50 is fastened to the base plate 10.

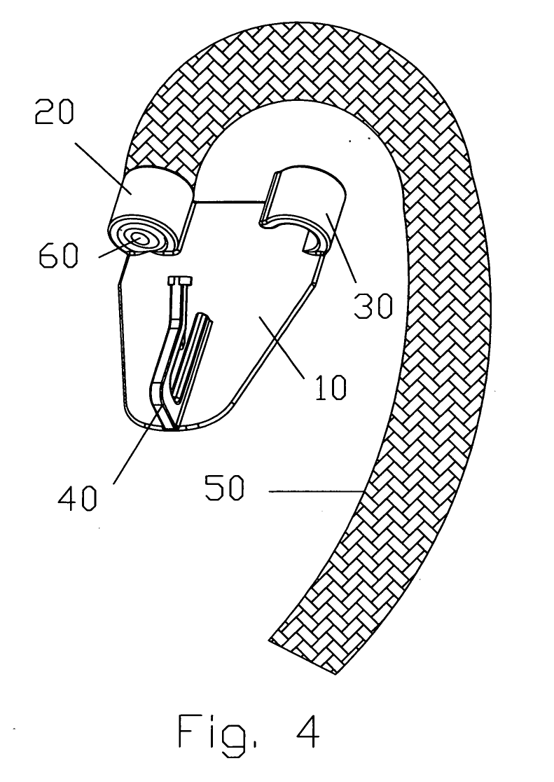

FIG. 4 show the parts connected into a complete halter.

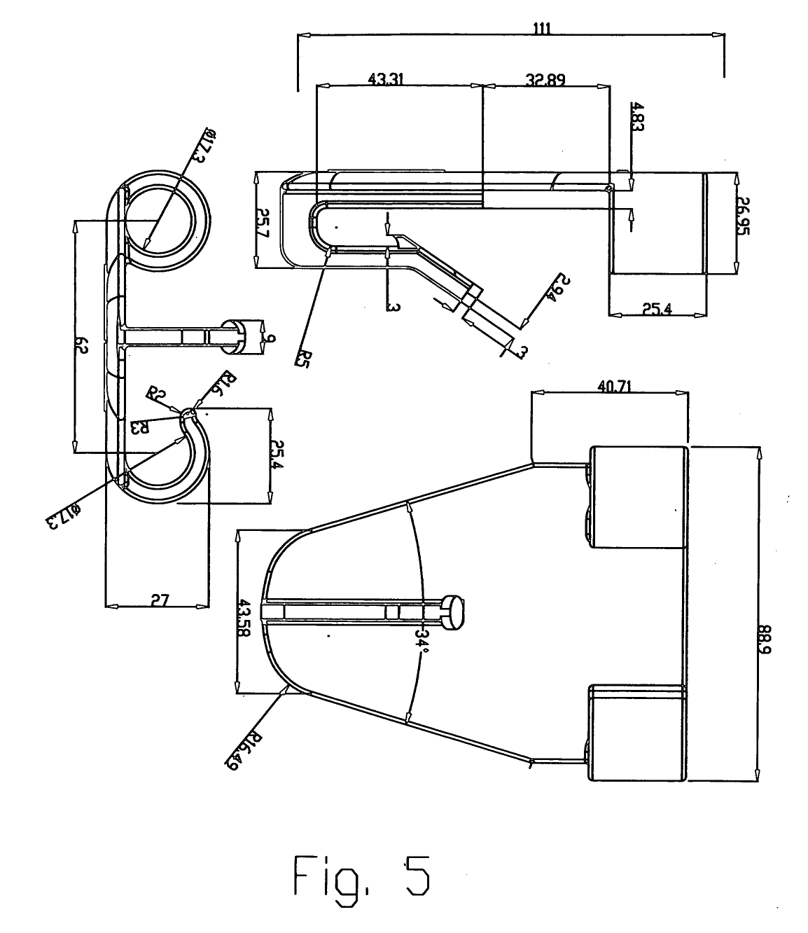

FIG. 5 is a dimentioned drawing of the preferred embodiment.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. an article of manufacture for haltering a horse or any other like animal typically controlled by the use of a halter comprised of a base plate which is a single piece of injection molded or otherwise machined or manufactured material with attached rope.

2. the base plate of claim 1 wherein said body of material is composed of any predetermined substance having substantially the properties of strength and flexibility.

3. the base plate of claim 1 wherein a means to secure said rope to the base plate is provided.

4. the base plate of claim 1 wherein a means for locking said rope to said base plate is provided in at least one location whereby the animal is not required to insert its nose into an assemblage of of straps to be haltered.

5. a method of haltering an animal comprising:
a) providing a halter comprising a base plate and rope, said rope secured to said base plate.
b) providing said rope to encircle neck of said animal, hooking into said base plate forming secure attachment around neck of said animal.
c) providing said rope to further loop over nose of said animal hooking again in said base plate whereby said animal is haltered and secured in the most stress free method possible to date.
